(19) United States
(12) Patent Application Publication
(10) Pub. No.: US 2012/0239517 A1
(43) Pub. Date: Sep. 20, 2012

(54) DISTRIBUTED NETWORK FOR PERFORMING COMPLEX ALGORITHMS

(75) Inventors: Antoine Blondeau, S A R (HK); Adam Cheyer, Oakland, CA (US); Babak Hodjat, Dublin, CA (US); Peter Harrigan, San Francisco, CA (US)

(73) Assignee: GENETIC FINANCE (BARBADOS) LIMITED, Belleville (BB)

(21) Appl. No.: 13/443,546

(22) Filed: Apr. 10, 2012

Related U.S. Application Data
(62) Division of application No. 12/267,287, filed on Nov. 7, 2008.
(60) Provisional application No. 60/986,533, filed on Nov. 8, 2007.
(60) Provisional application No. 61/075,722, filed on Jun. 25, 2008.

(51) Int. Cl. G06N 3/08; G06Q 20/08

(52) U.S. Cl. 705/26.1; 705/39; 706/13

(57) ABSTRACT

The cost of performing sophisticated software-based financial trend and pattern analysis is significantly reduced by distributing the processing power required to carry out the analysis and computational task across a large number of networked individual or cluster of computing nodes. To achieve this, the computational task is divided into a number of sub tasks. Each sub task is then executed on one of a number of processing devices to generate a multitude of solutions. The solutions are subsequently combined to generate a result for the computational task. The individuals controlling the processing devices are compensated for use of their associated processing devices. The algorithms are optionally enabled to evolve over time. Thereafter, one or more of the evolved algorithms is selected in accordance with a predefined condition.

### CROSS-REFERENCES TO RELATED APPLICATIONS

The present application is a divisional of U.S. Ser. No. 12/267,287, filed 7 Nov. 2008, entitled “Distributed Network for Performing Complex Algorithms,” which claims benefit under 35 USC 119(e) of both U.S. provisional application No. 60/986,533, filed 8 Nov. 2007, entitled “Distributed Network for Performing Complex Algorithms”, and U.S. provisional application No. 61/075722, filed 25 Jun. 2008, entitled “Distributed Network for Performing Complex Algorithms”. Each of the above applications is incorporated herein by reference in its entirety.

### BACKGROUND OF THE INVENTION

Complex financial trend and pattern analysis processing is conventionally done by supercomputers, mainframes or powerful workstations and PCs, typically located within a firm's firewall and owned and operated by the firm's Information Technology (IT) group. The investment in this hardware, and in the software to run it, is significant. So is the cost of maintaining (repairs, fixes, patches) and operating (electricity, securing data centers) this infrastructure.

Stock price movements are generally unpredictable but occasionally exhibit predictable patterns. Genetic Algorithms (GA) are known to have been used for stock trading problems. This application has typically been in stock categorization. According to one theory, at any given time, 5% of stocks follow a trend. Genetic algorithms are thus sometimes used, with some success, to categorize a stock as following or not following a trend.

Evolutionary algorithms, which are supersets of Genetic Algorithms, are good at traversing chaotic search spaces. As has been shown by Koza, J. R., “Genetic Programming: On the Programming of Computers by Means of Natural Selection”, 1992, MIT Press, an evolutionary algorithm can be used to evolve complete programs in declarative notation. The basic elements of an evolutionary algorithm are an environment, a model for a gene, a fitness function, and a reproduction function. An environment may be a model of any problem statement. A gene may be defined by a set of rules governing its behavior within the environment. A rule is a list of conditions followed by an action to be performed in the environment. A fitness function may be defined by the degree to which an evolving rule set is successfully negotiating the environment. A fitness function is thus used for evaluating the fitness of each gene in the environment. A reproduction function produces new genes by mixing rules with the fittest of the parent genes. In each generation, a new population of genes is created.

At the start of the evolutionary process, genes constituting the initial population are created entirely randomly, by putting together the building blocks, or alphabet, that constitutes a gene. In genetic programming, this alphabet is a set of conditions and actions making up rules governing the behavior of the gene within the environment. Once a population is established, it is evaluated using the fitness function. Genes with the highest fitness are then used to create the next generation in a process called reproduction. Through reproduction, rules of parent genes are mixed, and sometimes mutated (i.e., a random change is made in a rule) to create a new rule set. This new rule set is then assigned to a child gene that will be a member of the new generation. In some incarnations, the fittest members of the previous generation, called elitists, are also copied over to the next generation.

### BRIEF SUMMARY OF THE INVENTION

In accordance with the present invention, a scalable and efficient computing apparatus and method, provide and maintain financial trading edge and maintain it through time. This is achieved, in part, by combining (i) advanced Artificial Intelligence (AI) and machine learning algorithms, including Genetic Algorithms and Artificial Life constructs, and the like; (ii) a highly scalable distributed computing model tailored to algorithmic processing; and (iii) a unique computing environment that delivers cloud computing capacity on an unprecedented scale and at a fraction of the financial industry's cost.

The relationship with those supplying the computing power (assets), as described further below, is leveraged in a number of ways. The combination of large-scale computing power so supplied together with its low cost enable searching operations over a significantly larger solution space than those known in the prior art. As is well known, rapidly searching a large space of stocks, indicators, trading policies, and the like is important as the parameters affecting successful predictions is likely to change over time. Also, the more the processing power, the larger the search space can afford to be, presenting the promise of better solutions.

To increase the viral coefficient (i.e., the coefficient determining the rate at which the present invention is spread to and adopted by the CPU holders/providers to encourage them to join the computing network of the present invention) the providers of the computing power are compensated or given an incentive for making their computing power available to systems of the present invention and may be further compensated or given an incentive for promoting and encouraging others to join.

In accordance with one aspect of the present invention, appropriate compensation is given to providers for the use of their CPUs' computing cycles, dynamic memory, and the use of their bandwidth. This aspect of the relationship, in accordance with some embodiments of the present invention, enable viral marketing. The providers, upon learning of the compensation level, which may be financial, or in the form of goods/services, information or the like, will start communicating with their friends, colleagues, family, etc, about the opportunity to benefit from their existing investment in computing infrastructure. This resulting in an ever increasing number of providers contributing to the system, resulting, in turn, in higher processing power and therefore a higher performance. The higher the performance, the more resources can then be assigned to recruiting and signing more providers.

In accordance with some embodiments of the present invention, messaging and media delivery opportunities, e.g. regular news broadcasting, breaking news, RSS feeds, ticker tape, forums and chats, videos, etc., may be supplied to the providers.

Some embodiments of the present invention act as a catalyst for creation of a market for processing power. Accordingly, a percentage of the processing power supplied by the providers in accordance with embodiments of the present invention may be provided to others interested in accessing such a power.

To speed viral marketing and the rate of adoption of the embodiments of the present invention, a referral system may be put in place. For example, in some embodiments, “virtual coins” are offered for inviting friends. The virtual coins may be redeemable through charitable gifts or other information gifts at a rate equal or less than typical customer acquisition costs.

A method for performing a computational task, in accordance with one embodiment of the present invention includes, in part, forming a network of processing devices with each processing device being controlled by and associated with a different entity; dividing the computational task into sub tasks, running each sub task on a different one of the processing devices to generate a multitude of solutions, combining the multitude of solutions to generate a result for the computational task; and compensating the entities for use of their associated processing devices.

In one embodiment, the computational task represents a financial algorithm. In one embodiment, at least one of the processing devices includes a cluster of central processing units. In one embodiment, at least one of the entities is compensated financially. In one embodiment, at least one of the processing devices includes a central processing unit and a host memory. In one embodiment, the result is a measure of a risk-adjusted performance of one or more assets. In one embodiment, at least one of the entities is compensated in goods/services.

A method for performing a computational task, in accordance with one embodiment of the present invention includes, in part, forming a network of processing devices with each processing device being controlled by and associated with a different one of entities, distributing one or more algorithms randomly among the processing devices, enabling the one or more algorithms to evolve over time, selecting the evolved algorithms in accordance with a predefined condition, and applying the selected algorithm to perform the computational task. The computational task represents a financial algorithm.

In one embodiment, the entities are compensated for use of their processing devices. In one embodiment, at least one of the processing devices includes a cluster of central processing units. In one embodiment, at least one of the entities is compensated financially. In one embodiment, at least one of the processing devices includes a central processing unit and a host memory. In one embodiment, at least one of the algorithms provides a measure of a risk-adjusted performance of one or more assets. In one embodiment, at least one of the entities is compensated in goods/services.

A networked computer system configured to perform a computational task, in accordance with one embodiment of the present invention, includes, in part, a module configured to divide the computational task into a multitude of subtasks, a module configured to combine a multitude of solutions generated in response to the multitude of computational task so as to generate a result for the computational task, and a module configured to maintain a compensation level for the entities generating the solutions. The computational task represents a financial algorithm.

In one embodiment, at least one of the solutions is generated by a cluster of central processing units. In one embodiment, the compensation is a financial compensation. In one embodiment, the result is a measure of a risk-adjusted performance of one or more assets. In one embodiment, the compensation for at least one of the entities is in goods/services.

A networked computer system configured to perform a computational task, in accordance with one embodiment of the present invention, includes, in part, a module configured to distribute a multitude of algorithms, enabled to evolve over time, randomly among a multitude of processing devices, a module configured to select one or more of the evolved algorithms in accordance with a predefined condition, and a module configured to apply the selected algorithm(s) to perform the computational task. The computational task represents a financial algorithm.

In one embodiment, the networked computer system further includes a module configured to maintain a compensation level for each of the processing devices. In one embodiment, at least one of the processing devices includes a cluster of central processing units. In one embodiment, at least one compensation is in the form of a financial compensation. In one embodiment, at least one of the processing devices includes a central processing unit and a host memory. In one embodiment, at least one of the algorithms provides a measure of a risk-adjusted performance of one or more assets. In one embodiment, at least one compensation is in the form of goods/services.

### BRIEF DESCRIPTION OF THE DRAWINGS

FIG. 1 is an exemplary high-level block diagram of a network computing system, in accordance with one embodiment of the present invention.

FIG. 2 shows a number of client-server actions, in accordance with one exemplary embodiment of the present invention.

FIG. 3 shows a number of components/modules disposed in the client and server of FIG. 2.

FIG. 4 is a block diagram of each processing device of FIG. 1.

### DETAILED DESCRIPTION OF THE INVENTION

In accordance with one embodiment of the present invention, the cost of performing sophisticated software-based financial trend and pattern analysis is significantly reduced by distributing the processing power required to achieve such analysis across a large number, e.g., thousands, millions, of individual or clustered computing nodes worldwide, leveraging the millions of Central Processing Units (CPUs) or Graphical Processing Units (GPUs) connected to the Internet via a broadband connection. Although the following description is provided with reference to CPUs, it is understood that the embodiments of the present invention are equally applicable to GPUs.

As used herein:
a system refers to a hardware system, a software system, or a combined hardware/software system;
a provider may include an individual, a company, or an organization that has agreed to join the distributed network computing system of the present invention and owns, maintains, operates, manages or otherwise controls one ore more central processing units (CPU);
a network is formed by several elements including a central or origination/termination computing infrastructure and any number N of providers, each provider being associated with one or more nodes each having any number of processing devices. Each processing device includes at least one CPU and/or a host memory, such as a DRAM;
a CPU is configured to supports one or more nodes to form a portion of the Network; a node is a network element adapted to perform computational tasks. A single node may reside on more than one CPU, such as the multiple CPUs of a multi-core processor; and
a broadband connection is defined as a high speed data connection over either cable, DSL, WiFi, 3G wireless, 4G wireless, or any other existing or future wireline or wireless standard that is developed to connect a CPU to the Internet, and connect the CPUs to one another.

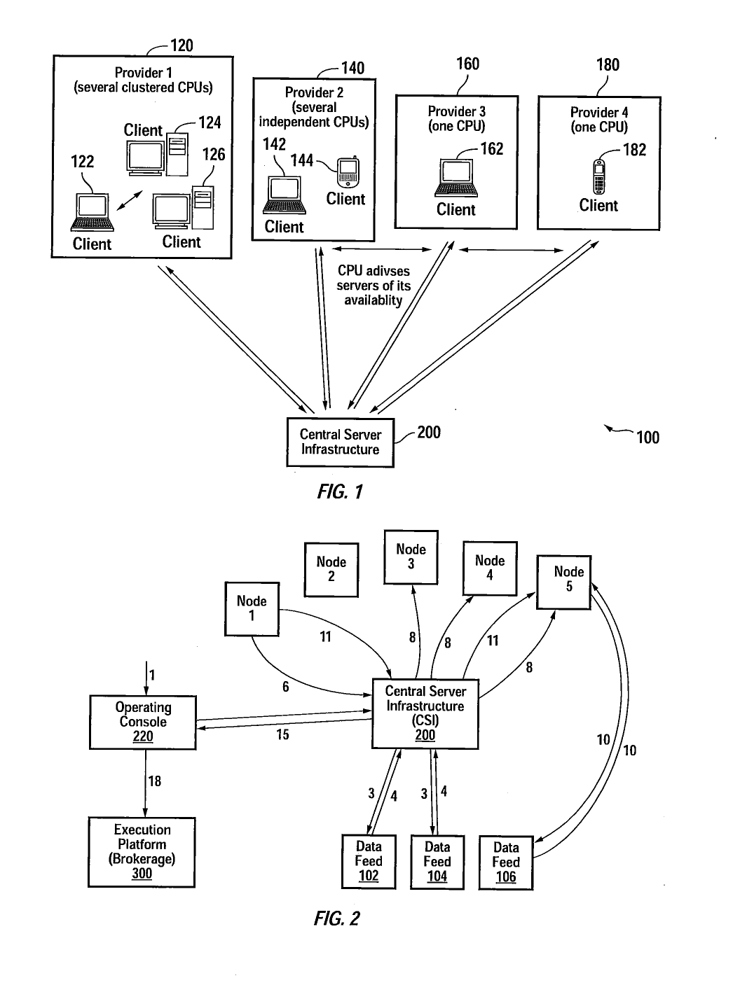

FIG. 1 is an exemplary high-level block diagram of a network computing system 100, in accordance with one embodiment of the present invention. Network computing system 100 is shown as including four providers 120, 140, 160, 180, and one or more central server infrastructure (CSI) 200. Exemplary provider 120 is shown as including a cluster of CPUs hosting several nodes owned, operated, maintained, managed or otherwise controlled by provider 120. This cluster includes processing devices 122, 124, and 126. In this example, processing device 122 is shown as being a laptop computer, and processing devices 124 and 126 are shown as being desktop computers. Similarly, exemplary provider 140 is shown as including a multitude of CPUs disposed in processing device 142 (laptop computer) and processing device 144 (handheld digital communication/computation device) that host the nodes owned, operated, maintained, managed or otherwise controlled by provider 120. Exemplary provider 160 is shown as including a CPU disposed in the processing device 162 (laptop computer), and exemplary provider 180 is shown as including a CPU disposed in processing device 182 (cellular/VoIP handheld device). It is understood that a network computing system, in accordance with the present invention, may include any number N of providers, each associated with one node or more nodes and each having any number of processing devices. Each processing device includes at least one CPU and/or a host memory, such as a DRAM.

A broadband connection connects the providers to CSI 200 to perform computing operations of the present invention. Such connection may be cable, DSL, WiFi, 3G wireless, 4G wireless or any other existing or future wireline or wireless standard that is developed to connect a CPU to the Internet. In some embodiments, the nodes are also enabled to connect and pass information to one another, as shown in FIG. 1. Providers 140, 160 and 180 of FIG. 1 are shown as being in direct communication with and pass information to one another. Any CPU may be used if a client software, in accordance with the present invention, is enabled to run on that CPU. In some embodiments, a multiple-client software provides instructions to multiple-CPU devices and uses the memory available in such devices.

In one embodiment, network computing system 100 implements financial algorithms/analysis and computes trading policies. To achieve this, the computational task associated with the algorithms/analysis is divided into a multitude of sub-tasks each of which is assigned to and delegated to a different one of the nodes. The computation results achieved by the nodes are thereafter collected and combined by CSI 200 to arrive at a solution for the task at hand. The sub-task received by each node may include an associated algorithm or computational code, data to be implemented by the algorithm, and one or more problems/questions to be solved using the associated algorithm and data. Accordingly, in such embodiments, CSI 200 receives and combines the partial solutions supplied by the CPU(s) disposed in the nodes to generate a solution for the requested computational problem, described further below. When the computational task being processed by network computing system 100 involves financial algorithms, the final result achieved by integration of the partial solutions supplied by the nodes may involve a recommendation on trading of one or more assets.

Scaling of the evolutionary algorithm may be done in two dimensions, namely by pool size, and/or evaluation. In an evolutionary algorithm, the larger is the pool, or population of genes, the greater is the diversity over the search space. This means that the likelihood of finding fitter genes goes up. In order to achieve this, the pool can be distributed over many processing clients. Each processor evaluates its pool of genes and sends the fittest genes to the server, as described further below.

In accordance with one embodiment of the present invention, financial rewards are derived by executing the trading policies suggested by a winning algorithm(s) associated with a winning node and in accordance with the regulatory requirements. The genes or entities in algorithms, such as genetic algorithms or AI algorithm described further below, implemented by such embodiments, may be structured so as to compete for the best possible solution and to achieve the best results. In these algorithms, each provider, e.g., providers 120, 140, 160 and 180 of FIG. 1, receives, at random, the complete algorithm (code) for performing a computation and is assigned one or several node IDs. In one embodiment, each provider is also enabled to add, over time, its knowledge and decisions to its associated algorithm. The algorithms may evolve and some will emerge as being more successful than others. In other words, in time, one or more of the algorithms (initially assigned on a random basis) will develop a higher level of intelligence than others and become wining algorithms and may be used to execute trading recommendations. The nodes developing the winning algorithms are referred to as winning nodes. The node ID is used for tracing the winning algorithms back to their nodes to identify the winning nodes. CSI 200 may structure an algorithm by either selecting the best algorithm or by combining partial algorithms obtained from multiple CPUs. The structured algorithm may be defined entirely by the wining algorithm or by a combination of the partial algorithms generated by multiple nodes or CPUs. The structured algorithm is used to execute trades.

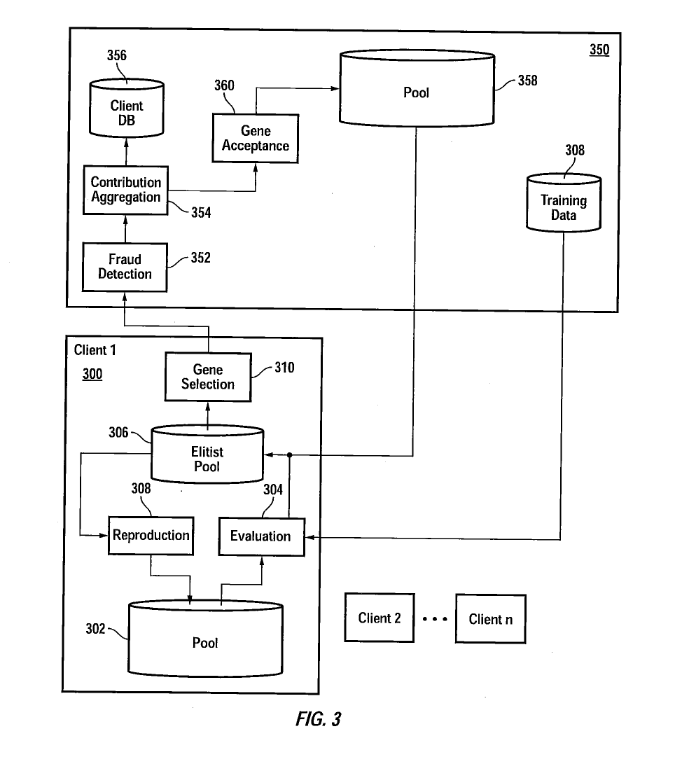

In some embodiments, as shown in FIG. 2, a feedback loop is used to provide the CPUs with updates on how well their respective algorithms are evolving. These may include the algorithms that their associated CPUs have computed or algorithms on assets that are of interest to the associated Providers. This is akin to a window on the improvement of the algorithm components through time, providing such information as the number of Providers working on the algorithm, the number of generations that have elapsed, etc. This constitutes additional motivation for the Providers to share their computing power, as it provides them with the experience to participate in a collective endeavor.

In some embodiments, the algorithm implemented by the individual CPUs or the network computing system of the present invention provides a measure of risk-adjusted performance of an asset or a group of assets; this measure is commonly referred to in financial literature as alpha of the asset or group of assets. An alpha is usually generated by regressing an asset, such as a security or mutual fund's excess return, on the S&P 500 excess return. Another parameter commonly known as beta is used to adjust for the risk (the slope coefficient), whereas alpha is the intercept.

For example assume that a mutual fund has a return of 25%, and the short-term interest rate is 5% (excess return is 20%). Assume that during the same time period, the market excess return is 9%. Further assume that the beta of the mutual fund is 2.0. In other words the mutual fund is assumed to be twice as risky as the S&P 500. The expected excess return given the risk is 2×9%=18%. The actual excess return is 20%. Hence, the alpha is 2% or 200 basis points. Alpha is also known as the Jensen Index and is defined by the following expression:

$$\frac{\sum y - b \sum x}{n}$$

### Where:

n=number of observations (e.g., 36 mos.);
b=beta of the fund;
x=rate of return for the market; and
y=rate of return for the fund

An Artificial Intelligence (AI) or Machine Learning-grade algorithms is used to identify trends and perform analysis. Examples of AI algorithms include Classifiers, Expert systems, case based reasoning, Bayesian networks, Behavior based AI, Neural networks, Fuzzy systems, Evolutionary computation, and hybrid intelligent systems. A brief description of these algorithms is provided in Wikipedia and stated below.

Classifiers are functions that can be tuned according to examples. A wide range of classifiers are available, each with its strengths and weaknesses. The most widely used classifiers are neural networks, support vector machines, k-nearest neighbor algorithms, Gaussian mixture models, naive Bayes classifiers, and decision trees. Expert systems apply reasoning capabilities to reach a conclusion. An expert system can process large amounts of known information and provide conclusions based on them.

A case-based reasoning system stores a set of problems and answers in an organized data structure called cases. A case based reasoning system upon being presented with a problem finds a case in its knowledge base that is most closely related to the new problem and presents its solutions as an output with suitable modifications. A behavior based AI is a modular method of building AI systems by hand. Neural networks are trainable systems with very strong pattern recognition capabilities.

Fuzzy systems provide techniques for reasoning under uncertainty and have been widely used in modern industrial and consumer product control systems. An Evolutionary Computation applies biologically inspired concepts such as populations, mutation and survival of the fittest to generate increasingly better solutions to the problem. These methods most notably divide into evolutionary algorithms (e.g., genetic algorithms) and swarm intelligence (e.g., ant algorithms). Hybrid intelligent systems are any combinations of the above. It is understood that any other algorithm, AI or otherwise, may also be used.

To enable such a distribution while at the same time protecting the safety of the financial data exchanged between nodes, associated with providers described below, as well as the integrity of a winning pattern, described further below, no node will know i) whether it is addressing the whole trend/pattern computation or only a portion of it, and ii) whether the result of the node's computation is leveraged by the system to decide on a financial trading policy and to execute on that trading policy.

The processing of the algorithm is separated from the execution of trading orders. Decision to trade and execution of trading orders is made by one or several central servers or termination servers depending on whether the infrastructure is organized as a client-server or as a peer-to-peer grid computing model. Trading decisions are not made by the Providers' nodes. A provider, also referred to herein as a node owner or node, as described further below, refers to an individual, company, or an organization who has agreed to join the distributed network of the present invention and owns, maintains, operates, manages or otherwise controls one ore more CPUs. The Providers are thus treated as sub-contractors and are not legally or financially responsible in any way for any trade.

Providers willingly lease and make available their CPUs' processing power and memory capacity, in accordance with the present invention, by signing a document, referred to herein as a Provider License Agreement (PLA), that governs the terms of the engagement. A PLA stipulates the minimum requirements under which each Provider agrees to share its CPU, in accordance with the present invention, and defines confidentiality and liability issues. A PLA stipulates that the associated Provider is not an end-user and does not benefit from the results of its CPUs' computing operations. The PLA also sets forth the conditions that must be met by the Providers in order to receive remuneration for leasing their computing infrastructure.

The providers are compensated for making their CPU power and memory capacity accessible to the network system of the present invention. The compensation may be paid regularly (e.g. every month) or irregularly; it may the same for each period or it may different for different periods, it may be related to a minimum computer availability/usage threshold, which could be measured through a ping mechanism (to determine availability), or calculated in CPU cycles used (to determine usage), or any other possible indicator of a CPU activity. In one embodiment, no compensation is paid if the availability/usage threshold is not reached. This encourages the providers (i) to maintain a live broadband connection to an available CPU on a regular basis and/or (ii) to discourage the providers from using their available CPU power for other tasks. Moreover, the compensation may be paid on a per CPU basis to encourage Providers to increase the number of CPUs they make available to the present invention. Additional bonuses may be paid to Providers who provide CPU farms to the present invention. Other forms of non-cash based compensation or incentive schemes may be used alone, or in combination with cash based compensation schemes, as described further below.

Providers, upon registering and joining the network system of the present invention download a client software, suitable to their CPU type and characteristics, and configured to either self-install or be installed by the provider. The client software provides a simple, visual representation of the service, such as a screen saver. This representation indicates to the Providers the amount of money they may make for each period. This representation may, for example, take the form of coins tumbling into a cash register. This enhances the visual effects of the benefits being offered by joining the network system of the present invention. Since the client software is running in the background no perceivable effect is experienced on the computers.

The client software may be updated regularly to enhance the interactive experience of its associated provider. To achieve this, in one embodiment, a “crowd sourcing” knowledge module is disposed in the client software to ask individuals, for example, to make market predictions, and to leverage aggregate perspectives as one or more aspects of the learning algorithm of the present invention.

As part of developing a more interactive experience, the providers may be offered the opportunity to select which asset, such as funds, commodities, stocks, currencies, etc. they would like their CPU(s) to analyze. Such a choice may be carried out on a free basis, or from a list or portfolio of assets submitted to the providers.

In one embodiment, the screensaver/interactive client software is periodically updated with news about one or more assets, including company news, stock charts, etc. The “feel good” effect of such a presentation to Providers is important, particularly to those who are not savvy investors. By downloading the present invention and selecting, for example, a few stocks of interest, Providers can feel involved in the world of finance. The sophisticated-looking financial screensaver of the present invention is designed to increase the impression of being involved in finance, a “halo” effect that serves to advance the viral marketing concept of the present invention.

The providers, once they start making money or start receiving satisfaction from the incentives received in accordance with the present invention, will start communicating with their friends, colleagues, family, etc. about the opportunity to earn back some money or incentive “credits” from their existing investments in computing infrastructure. This results in an ever increasing number of nodes being contributed to the service, which in turn, results in higher processing power, and therefore a higher business performance. The higher the business performance, the more can be spent on recruiting and adding more Providers.

In some embodiments, an incentive is added to speed the rate of membership and the viral marketing aspect of the present invention, as described further below. For example, in one embodiment, a referral system is put in place according to which existing Providers are paid a referral fee to introduce new Providers. Providers may also be eligible to participate in a periodic lottery mechanism, where each Provider who has contributed at least a minimum threshold of CPU capacity over a given period is entered into a lucky-draw type lottery. The lucky-draw winner is awarded, for example, a cash bonus, or some other form of compensation. Other forms of award may be made, for example, by (i) tracking the algorithms' performance and rewarding the Provider who has the winning node, i.e. the node that is determined to have structured the most profitable algorithm over a given period and thus has the winning algorithm; (ii) tracking subsets of a winning algorithm, tagging each of these subsets with an ID, identifying the winning node, and rewarding all Providers whose computer-generated algorithm subsets' IDs is found in the winning algorithm; and (iii) tracking and rewarding the CPU(s) that have the highest availability over a given period.

In some embodiments, an incentive is added when individual Providers join with others, or invite others to form “Provider Teams” that can then increase their chances to win the available bonus prizes. In other embodiments, a game plan, such as the opportunity to win a bonus for a correct or for best prediction out of the “crowd sourcing” knowledge may be used as a basis for the bonus.

In order to minimize account and cash handling logistics, in some embodiments, a virtual cash account is provided for each Provider. Each account is credited periodically, such as every month, with the remuneration fee paid to the Provider, as described above. Any cash credited to the cash account may constitute a booked expense; it will not convert into an actual cash outflow until the Provider requests a bank transfer to his/her physical bank.

Providers may be compensated for the shared use of their CPUs in many other ways. For example, the Providers may be offered trading tips instead of cash. A trading tip includes buy or sell triggers for specific stocks, or for any other asset. Subject to the prevailing laws about offering trading advice, the trading tips could be drawn, for example, at random, drawn on a list of assets which an entity using the present invention is not trading or does not intend to trade. Such trading tips may also be provided for assets the Providers either own, as a group or individually, or have expressed interest in, as described above. In some embodiments, a maintenance fee is charged for the Providers' accounts in order to pay for Providers' account-related operations.

The presence of the client software on the Provider's CPU provides advertising opportunities (by advertising to Providers) which may be marketed to marketers and advertisers. Highly targeted advertising opportunities are presented by gaining knowledge about the Providers' areas of interests, in terms of, for example, assets types, specific companies, funds, etc. In addition, the CPU client provides messaging and media delivery opportunities, e.g., news broadcasting, breaking news, RSS feeds, ticker tape, forums and chats, videos, etc. All such services may be available for a fee, debited directly from the Provider's account. An interactive front-end application—used in place of a screen saver—that includes associated routines running in background achieves such functionality.

Trading signals may be sold to providers as well as to non-providers, both on an individual or institutional basis, subject to prevailing laws and regulations. Trading signals are generated from the trend & analysis work performed by the present invention. The client software may by customized to deliver such signals in an optimal fashion. Service charges may be applied to Providers' accounts automatically. For example, a Provider may receive information on a predefined number of stocks per month for an agreed upon monthly fee.

A number of APIs, Application Programming Interface components and tools, may also be provided to third-party market participants, e.g., mutual fund and hedge fund managers, to benefit from the many advantages that the present invention provides. Such third-party participants may, for example, (i) trade on the trading model provided by the present invention, (ii) build their own trading models by utilizing the software, hardware and process infrastructure provided by this invention and in turn share or sell such models to other financial institutions. For example, an investment bank may lease X million computing cycles and a set of Y programming routines (AI-based software executables) for a period of Z hours from an entity using the present invention at a cost of W dollars to determine up-to-date trends and trading patterns for, e.g., oil futures. As such, the present invention provides a comprehensive trading policy definition tool and execution platform leveraging a uniquely powerful trend/pattern analysis architecture.

A Provider's account may also be used as a trading account or source of funds for opening an account with one or more online brokerage firms. A referral fee can thus be collected from the online brokerage firms in return for introducing a known base of customers to them. The infrastructure (hardware, software), API and tools, etc. of the present invention may also be extended to solving similarly complex computing tasks in other areas such as genetics, chemical engineering, economics, scenario analysis, consumer behavior analysis, climate and weather analysis, defense and intelligence, etc.

### Client-Sever Configuration

A network, in accordance with one embodiment of the present invention, includes at least five elements, three of which elements (i, ii, and iii shown below) execute software in accordance with various embodiments of the present invention. These five elements include a (i) central server infrastructure, (ii) an operating console, (iii) the network nodes (or nodes), (iv) an execution platform (a portion of which typically belongs to a prime broker), and (iv) data feed servers, which typically belongs to a prime broker or a financial information provider.

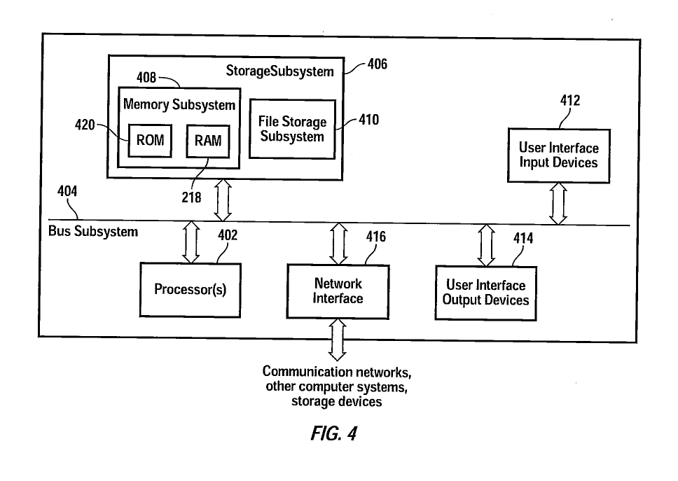

Referring to FIG. 3, CSI 200 includes one or more computing servers. CSI 200 is configured to operate as the aggregator of the nodes' processing work, and as their manager. This “control tower” role of CSI 200 is understood both from a computing process management perspective, i.e. which nodes compute, in which order, and on what type of problem and data from among the various problems and data under consideration. CSI 200 operations are also understood from a computing problem definition and resolution perspective, i.e., the formatting of the computing problems which the nodes will be asked to compute, the evaluation of nodes' computing results against a specific performance threshold, and the decision to carry on with processing or stop processing if the results are deemed appropriate.

CSI 200 may include a log server (not shown) adapted to listen to the nodes' heartbeat or regular requests in order to understand and manage the network's computing availability. CSI 200 may also access data feeds 102, 104, and 106, and other external information sources to obtain relevant information—that is, information required to solve the problem at hand. The packaging of the problem and the data may happen at the CSI 200. However, the nodes are configured to conduct their information gathering themselves as well, to the extent that this is legally and practically possible, as described further below.

Although CSI 200 is shown in this embodiment as a single block and as one functional entity, CSI 200 may, in some embodiments, be a distributed processor. Furthermore, CSI 200 may also be a part of a hierarchical, federated topologies, where a CSI can actually masquerade as a node (see below) to connect as a client to a parent CSI.

In accordance with some embodiments, e.g., when a genetic algorithm is used, the CSI is arranged as a tiered system, also referred to as federated client-server architecture. In such embodiments, the CSI maintains the most accomplished results of the genetic algorithm. A second component, that includes a number of nodes, is assigned the task of processing the genetic algorithm and generating performing “genes” as described further below. A third component evaluates the genes. To achieve this, the third component receives formed and trained genes from the second tier and evaluates them on portions of the solution space. These evaluations are then aggregated by the second tier, measured against a threshold set by what is—at this specific time the—minimum performance level attained by the genes maintained at the CSI. The genes that compare favorably against the threshold (or a portion thereof) are submitted to the CSI by the system's third tier. Such embodiments free up the CSI from doing the evaluation, described in Action 12 below, and enable a more efficient operation of the system.

There are a number of advantages associated with a tiered-system, in accordance with the present invention. First, the scalability of client server communication is enhanced as there are multiple, intermediate servers, which in turn, enable the number of nodes to be increased. Second, by having different levels of filtration of the results at the federated servers, before these results are forwarded to the main server, the load on the central server is reduced. In other words, since the nodes (clients) are in communications with their local servers, which in turn, are in communications with a central server, the load on the central server is reduced. Third, any given task may be allocated to a particular segment of the network. As a result, selected portions of the network may be specialized in order to control the processing power allocated to the task at hand. It is understood that any number of tiers may be used in such embodiments.

### Operating Console

Operating Console is the human-machine interface component required for human operators to interact with the System. Using the Operating Console 220, a human operator can enter the determinants of the specific problem he/she wishes the algorithms to solve, select the type of algorithm he/she wants to use, or select a combination of algorithms. The operator can dimension the size of the network, specifically the number of nodes he/she wants to reserve for a given processing task. The operator can input objectives as well as performance thresholds for the algorithm(s). The operator can visualize the results of the processing at any given time, analyze these results with a number of tools, format the resulting trading policies, as well as carry out trading simulations. The console also serves as a monitoring role in tracking the network load, failure and fail-over events. The console also provides information about available capacity at any time, warns of network failure, overload or speed issues, security issues, and keeps a history of past processing jobs. The operating console 2s0 interfaces with the execution platform 300 to execute trading policies. The formatting of the trading policies and their execution is either done automatically without human intervention, or is gated by a human review and approval process. The operating console enables the human operator to choose either one of the above.

### Network Nodes

The network nodes, or nodes, compute the problem at hand. Five such nodes, namely nodes 1, 2, 3, 4 and 5 are shown in FIG. 1. The nodes send the result of their processing back to CSI 200. Such results may include an evolved algorithm(s), that may be partial or full, and data showing how the algorithm(s) has performed. The nodes, if allowed under prevailing laws and if practical, may also access the data feeds 102, 104, 106, and other external information sources to obtain relevant information to the problem they are being asked to solve. In advanced phases of the system, the nodes evolve to provide further functionality in the form of an interactive experience to back to the providers, thus allowing the providers to input assets of interest, opinions on financial trends, etc.

### Execution Platform

The execution platform is typically a third-party-run component. The execution platform 300 receives trading policies sent from the operating console 220, and performs the required executions related to, for example, the financial markets, such as the New York Stock Exchange, Nasdaq, Chicago Mercantile Exchange, etc. The execution platform converts the instructions received from the operating console 220 into trading orders, advises the status of these trading orders at any given time, and reports back to the operating console 220 and to other “back office” systems when a trading order has been executed, including the specifics of that trading order, such as price, size of the trade, other constraints or conditions applying to the order.

### Data Feed Servers

The data feed servers are also typically third-party-run components of the System. Data feed servers, such as data feed servers 102, 104, 106, provide real-time and historical financial data for a broad range of traded assets, such as stocks, bonds, commodities, currencies, and their derivatives such as options, futures etc. They can be interfaced directly with CSI 200 or with the nodes. Data feed servers may also provide access to a range of technical analysis tools, such as financial indicators (MACD, Bollinger Bands, ADX, RSI, etc), that may be used by the algorithm(s) as “conditions” or “perspectives” in their processing. By using proper APIs, the data feed servers enable the algorithm(s) to modify the parameters of the technical analysis tools in order to broaden the range of conditions and perspectives and therefore increase the dimensions of the algorithms' search space. Such technical indicators may also computed by the system based on the financial information received via the data feed servers. The data feed servers may also include unstructured, or qualitative information for use by the algorithms so as to enable the system to take into account structured as well as unstructured data in its search space.

### Client-Server Configuration—Data and Process Flows

The following is an example of data and process flow, in accordance with one exemplary embodiment of the present invention. The various actions described below are shown with reference to FIG. 2. The arrows and its associated actions are identified using the same reference numbers.

### Action 1

A human operator chooses a problem space and one or more algorithms to address the problem space, using the operating console. The operator supplies the following parameters associated with action 1 to CSI 200 using operating console 220:

objectives: The objectives define the type of trading policy expected to result from the processing, and if necessary or appropriate, set a threshold of performance for the algorithm(s). An example is as follows. A trading policy may be issued to “buy”, “sell”, “sell short”, “buy to cover” or “hold” specific instruments (stocks, commodities, currencies, indexes, options, futures, combinations thereof, etc). The trading policy may allow leverage. The trading policy may include amounts to be engaged per instrument traded. The trading policy may allow overnight holding of financial instruments or may require that a position be liquidated automatically at a particular time of the day, etc.

search space: The search space defines the conditions or perspectives allowed in the algorithm(s). For example, conditions or perspectives include (a) financial instruments (stocks, commodities, futures etc), (b) raw market data for the specific instrument such as “ticks” (the market price of an instrument at a specific time), trading volume, short interest in the case of stocks, or open interest in the case of futures, (c) general market data such as the S&P500 stock index data, or NYSE Financial Sector Index (a sector specific indicator) etc. They can also include (d) derivatives—mathematical transformations—of raw market data such as “technical indicators”. Common technical indicators include [from the “Technical Analysis” entry on Wikipedia, dated Jun. 4, 2008]:
Accumulation/distribution index—based on the close within the day's range
Average true range—averaged daily trading range
Bollinger bands—a range of price volatility
Breakout—when a price passes through and stays above an area of support or resistance
Commodity Channel Index—identifies cyclical trends
Coppock—Edwin Coppock developed the Coppock Indicator with one sole purpose: to identify the commencement of bull markets
Elliott wave principle and the golden ratio to calculate successive price movements and retracements
Hikkake Pattern—pattern for identifying reversals and continuations
MACD—moving average convergence/divergence
Momentum—the rate of price change
Money Flow—the amount of stock traded on days the price went up
Moving average—lags behind the price action
On-balance volume—the momentum of buying and selling stocks
PAC charts—two-dimensional method for charting volume by price level
Parabolic SAR—Wilder's trailing stop based on prices tending to stay within a parabolic curve during a strong trend
Pivot point—derived by calculating the numerical average of a particular currency's or stock's high, low and closing prices
Point and figure charts—charts based on price without time
Profitability—measure to compare performances of different trading systems or different investments within one system
BPV Rating—pattern for identifying reversals using both volume and price
Relative Strength Index (RSI)—oscillator showing price strength
Resistance—an area that brings on increased selling
Rahul Mohindar Oscillator—a trend identifying indicator
Stochastic oscillator, close position within recent trading range
Support—an area that brings on increased buying
Trend line—a sloping line of support or resistance
Trix—an oscillator showing the slope of a triple-smoothed exponential moving average, developed in the 1980s by Jack Hutson

Conditions or perspectives may also include (e) fundamental analysis indicators. Such indicators pertain to the organization to which the instrument is associated with, e.g., the profit-earnings ratio or gearing ratio of an enterprise, (f) qualitative data such as market news, sector news, earnings releases, etc. These are typically unstructured data which need to be pre-processed and organized in order to be readable by the algorithm. Conditions or perspectives may also include (g) awareness of the algorithm's current trading position (e.g. is the algorithm “long” or “short” on a particular instrument) and current profit/loss situation.

adjustable algorithm: An adjustable algorithm defines specific settings, such as the maximum allowable rules or conditions/perspectives per rule, etc. For example, an algorithm may be allowed to have five ‘buy’ rules, and five ‘sell’ rules. Each of these rules may be allowed 10 conditions, such as 5 stock-specific technical indicators, 3 stock-specific “tick” data points and 2 general market indicators.

guidance: Guidance define any pre-existing or learned conditions or perspectives, whether human generated or generated, from a previous processing cycle, that would steer the algorithm(s) towards a section of the search space, in order to achieve better performance faster. For example, a guidance condition may specify that a very strong early morning rise in the market price of a stock would trigger the interdiction for the algorithm to take a short position (be bearish) on the stock for the day.

Data requirements: Data requirements define the historical financial data, up to the present time, required by the algorithms to i) train themselves, and ii) be tested. The data may include raw market data for the specific instrument considered or for the market or sectors, such as tick data and trading volume data-, technical analysis indicators data, fundamental analysis indicators data, as well as unstructured data organized into a readable format. The data needs to be provided for the extent of the “search space” as defined above. “Present time” may be understood as a dynamic value, where the data is constantly updated and fed to the algorithm(s) on a constant basis.

timeliness: Timeliness provides the operator with the option to specify a time by which the processing task is to be completed. This has an impact on how the CSI will prioritize computing tasks.

processing power allocation: In accordance with the processing power allocation, the operator is enabled to prioritize a specific processing task v. others, and bypass a processing queue (see below). The Operating Console communicates the above information to the CSI.

Trade Execution: In accordance with the trade execution, the operator stipulates whether the Operating Console will execute automatic trades based on the results of the processing activity (and the terms of these trades, such as the amount engaged for the trading activity), or whether a human decision will be required to execute a trade. All or a portion of these settings can be modified while the network is executing its processing activities.

### Action 2

There are two scenarios for this action. In either case, CSI 200 identifies whether the search space calls for data which it does not already possess.

Scenario A: upon receiving action 1 instructions from operating console 200, CSI 200 formats the algorithm(s) in a node (client-side) executable code.

Scenario B: CSI 200 does not format the algorithms in client-side (nodes) executable code. In this scenario, the nodes already contain their own algorithm code, which can be upgraded from time to time, as described further below with reference to Action 10. The code is executed on the nodes and the results aggregated, or chosen by CSI 200.

### Action 3

CSI 200 makes an API call to one or more data feed servers in order to obtain the missing data. For example, as shown in FIG. 2, CSI 200, upon determining that it does not have the 5 minute ticker data for the General Electric stock for years 1995 through 1999, will make an API call to data feed servers 102 and 104 to obtain that information.

### Action 4

In accordance with this action, the data feed servers upload the requested data to the CSI. For example, as shown in FIG. 2, data feed servers 102 and 104 upload the requested information to CSI 200.

### Action 5

Upon receiving the requested data from the data feed servers, CSI 200 matches this data with the algorithms to be performed and confirms the availability of all the required data. The data is then forwarded to CSI 200. In case the data is not complete, CSI 200 may raise a flag to inform the network nodes that they are required to fetch the data by themselves, as described further below.

### Action 6

There are two scenarios for this action. In accordance with the first scenario, the nodes may regularly ping the CSI to advise of their availability. In accordance with the second scenario, the nodes may make a request for instructions and data upon the node client being executed on the client machine CSI 200 becomes aware of the client only upon the client's accessing of CSI 200. In this scenario, CSI 200 does not maintain a state table for all connected clients.

### Action 7

By aggregating the nodes' heartbeat signals, i.e., a signal generated by the node indicating of its availability, or their instructions and data requests in conformity with the second scenario, CSI 200 is always aware of the available processing capacity. As described further below, aggregation refers to the process of adding the number of heartbeat signals associated with each node. CSI 200 also provides the operating console 220 with this information in real time. Based on this information as well as other instructions received from the operating console regarding, for example, timeliness, priority processing, etc. as described above with respect to action 1, CSI 200 decides either to (i) enforce a priority processing allocation (i.e., allocating client processing power based on priority of task) to a given number of nodes shortly thereafter, or (ii) add the new processing task to the activity queues of the nodes and manage the queues based on the timeliness requirements.

The CSI regularly and dynamically evaluates the progress of computations against the objectives, described further below, as well as matches the capacity against the activity queues via a task scheduling manager. Except in cases where priority processing is required (see action 1), the CSI attempts to optimize processing capacity utilization by matching it and segmenting it to address the demands of the activity queue. This action is not shown in FIG. 2.

### Action 8

Based on the number of available network nodes, as described above in action 7, the objectives/thresholds, timeliness requirements, and other such factors, the CSI 200 forms one or more distribution packages, which it subsequently delivers to the available nodes selected for processing. Included in a distribution package are, for example, (i) a representation (e.g., an XML representation) of the partial or full algorithm, which, in the case of a genetic algorithm, includes genes, (ii) the corresponding data, partial or complete (see Action 5 above), (iii) the node's computing activity settings and execution instructions, which may include a node-specific or generic computing objective/threshold, a processing timeline, a flag to trigger a call to request missing data from the node directly to data feed servers, etc. Threshold parameter may be defined, in one example, as the fitness or core performance metric of a worst-performing algorithm currently residing in the CSI 200. A processing timeline may include, for example, an hour or 24 hours. Alternatively a time-line may be open-ended. Referring to FIG. 2, CSI 200 is shown as being in communication with nodes 3 and 4 to enforce a priority processing allocation and to distribute a package to these nodes.

If a nodes already contains its own algorithm code, as described above in Action 2, as well as execution instructions, the package that it receives from the CSI typically includes only the data that the nodes require to execute its algorithm. Node 5 of FIG. 2 is assumed to contain its own algorithm and is shown as being in communication with CSI 200 to receive only data associated with action 8.

### Action 9

There are two possible scenarios for this action depending on the selected implementation. In accordance with the first scenario, CSI 200 sends the distribution package(s) to all the nodes selected for processing. In accordance with a second scenario, the CSI 200, upon request by the nodes, sends the distribution package, or relevant portion thereof as directed by the request, to each node that has sent such a request. This action is not shown in FIG. 2.

### Action 10

Each selected node interprets the content of the package sent by the CSI 200 and executes the required instructions. The nodes compute in parallel, with each node being directed to solving a task assigned to that node. If a node requires additional data to perform its computations, the associated instructions may prompt that node to upload more/different data into that nodes' local database from CSI 200. Alternatively, if configured to do so, a node may be able to access the data feed servers on its own and make a data upload request. Node 5 in FIG. 2 is shown as being in communication with data feed server 106 to upload the requested data.

Nodes may be configured to regularly ping the CSI for additional genes (when a genetic algorithm is used) and data. The CSI 200 may be configured to manage the instructions/data it sends to various nodes randomly. Consequently, in such embodiments, the CSI does not rely on any particular node.

Occasionally, updates to the nodes' client code (i.e., the executable code installed on the client) are also necessary. Accordingly, the code defining the execution instructions may direct the nodes' client to download and install a newer version of the code. The nodes' client loads its processing results to the node's local drive on a regular basis so that in the event of an interruption, which may be caused by the CSI or may be accidental, the node can pick up and continue the processing from where it left off. Accordingly, the processing carried out in accordance with the present invention does not depend on the availability of any particular node. Therefore, there is no need to reassign a particular task if a node goes down and becomes unavailable for any reason.

### Action 11

Upon reaching (i) the specified objective/threshold, as described above with reference to action 8, (ii) the maximum allotted time for computing, also described above with reference to action 8, or (iii) upon request from the CSI, a node calls an API running on the CSI. The call to the API may include data regarding the node's current availability, its current capacity (in the event conditions (i) or (ii) were not previously met and/or client has further processing capacity) process history since the last such communication, relevant processing results, i.e., latest solutions to the problem, and a check as to whether the node's client code needs an upgrade. Such communication may be synchronous, i.e., all the nodes send their results at the same time, or asynchronous, i.e., different nodes send their results at different times depending on the nodes' settings or instructions sent to the nodes. In FIG. 2, node 1 is shown as making an API call to CSI 200.

### Action 12

Upon receiving results from one or more nodes, the CSI starts to compare the results against i) the initial objectives; and/or ii) the results obtained by other nodes. The CSI maintains a list of the best solutions generated by the nodes at any point in time. In the case of a genetic algorithm, the best solutions may be, for example, the top 1,000 genes, which can be ranked in the order of performance and therefore be caused to set a minimum threshold for the nodes to exceed as they continue their processing activities. Action 12 is not shown in FIG. 2.

### Action 13

When a node contacts the CSI 200 as described in action 11, the CSI 200 may return instructions to that node that will cause that node to, for example, upload new data, upgrade itself (i.e., download and install a recent version of the client executable code), shut-down, etc. The CSI may be further configured to dynamically evolve the content of its distribution package. Such evolution may be carried out with respect to (i) the algorithm, (ii) the data sets selected to train or run the algorithm, (iii) or to the node's computing activity settings. Algorithm evolution may be performed by either incorporating improvements achieved as a result of the nodes' processing, or by adding dimensions to the search space in which the algorithm operates. The CSI 200 is configured to seed the nodes with client-executable code, as described above with reference to action 4. As a result, a new, improved, algorithm(s) is enabled to evolve.

### Action 14

The processes associated with the above actions are repeated on a continuous basis until one of the following conditions is satisfied: i) the objective is reached, ii) the time by which the processing task must be completed is reached (see action 2 described above), iii) a priority task is scheduled causing an interruption in the process, iv) the CSI's task schedule manager switches priorities in its management of the activity queue (see Action 7 above), or v) a human operator stops or cancels the computation.

If a task is interrupted, as in cases iii) or iv) above, the state of the algorithm(s), the data sets, the history of results and the node activity settings are cached at the CSI 200 in order to allow the task to resume when processing capacity is available again. The process termination is also signaled by the CSI 200 to any node that has been in contact with the CSI 200. At any given point, the CSI 200 may choose to ignore a node's request for contact, shut the node down, signal to the node that the job at hand has been terminated, etc.

### Action 15

The CSI 200 advises the status of the task processing activities to the operating console 220 on (i) a regular basis, (ii) upon request from the operating console 220, (iii) when the processing is complete, e.g. if the objective of the processing task has been reached, or (iv) the time by which the processing task must be completed is reached. At each status update or at completion of the processing activity, the CSI 200 provides what is referred to as the best algorithm at the time of the status update or completion. The best algorithm is the result of the processing activities of the nodes and the CSI 200, and of the comparative analysis performed on results and evolution activities undertaken by the network.

### Action 16

A decision to trade or not trade, based on the trading policy(ies) in accordance with the best algorithm(s) is made. The decision can be made automatically by the operating console 220, or upon approval by an operator, depending on the settings chosen for the specific task (see action 1). This action is not shown in FIG. 2.

### Action 17

The operating console 220 formats the trading order so that it conforms to the API format of the execution platform. The trading order may typically include (i) an instrument, (ii) a quantity of the instrument's denomination to be traded, (iii) a determination of whether the order is a limit order or a market order, (iv) a determination as to whether to buy or sell, or buy to cover or sell short in accordance with the trading policy(ies) of the selected best algorithm(s). This action is not shown in FIG. 2.

### Action 18

The Operating Console sends the trading order to the execution platform 300.

### Action 19

The trade is executed in the financial markets by the execution platform 300.

FIG. 3 shows a number of components/modules disposed in client 300 and server 350. As shown, each client includes a pool 302 of all the genes that have been initially created randomly by the client. The randomly created genes are evaluated using evaluation module 304. The evaluation is performed for every gene in the pool. Each gene runs over a number of randomly selected stocks or stock indices over a period of many days, e.g., 100 days. The evaluation is performed for every gene in the pool. Upon completion of the evaluation for all the genes, the best performing (e.g., the top 5%) of the genes are selected and placed in elitist pool 306.

The genes in the elitist pool are allowed to reproduce. To achieve this, gene reproduction module 308 randomly selects and combines two or more genes, i.e., by mixing the rules used to create the parent genes. Pool 302 is subsequently repopulated with the newly created genes (children genes) as well as the genes that were in the elitist pool. The old gene pool is discarded. The new population of genes in pool 302 continue to be evaluated as described above.

Gene selection module 310 is configured to supply better and more fitting genes to server 350, when so requested. For example, server 350 may send an inquiry to gene selection module 310 stating “the fitness for my worst gene is X, do you have better performing genes?”. Gene selection module 310 may respond by saying “I have these 10 genes that are better” and attempt to send those genes to the server.

Before a new gene is accepted by the sever 350, the gene goes through a fraud detection process by fraud detection module 352 disposed in the server. Contribution/aggregation module 354 is configured to keep track of the contribution by each client to aggregate this contribution. Some clients may be very active while others may not be. Some clients may be running on much faster machines than other. Client database 356 is updated by contribution/aggregation module 354 with the processing power contributed by each client.

Gene acceptance module 360 is configured to ensure that the genes arriving from a client are better than the genes already in server pool 358 before these genes are added to server pool 358. Accordingly, gene acceptance module 360 stamps each accepted gene with an ID, and perform a number of house cleaning operations prior to adding the accepted gene to server pool 358.

FIG. 4 shows various components disposed in each processing device of FIG. 1. Each processing device is shown as including at least one processor 402, which communicates with a number of peripheral devices via a bus subsystem 404. These peripheral devices may include a storage subsystem 406, including, in part, a memory subsystem 408 and a file storage subsystem 410, user interface input devices 412, user interface output devices 414, and a network interface subsystem 416. The input and output devices allow user interaction with data processing system 402.

Network interface subsystem 416 provides an interface to other computer systems, networks, and storage resources 404. The networks may include the Internet, a local area network (LAN), a wide area network (WAN), a wireless network, an intranet, a private network, a public network, a switched network, or any other suitable communication network. Network interface subsystem 416 serves as an interface for receiving data from other sources and for transmitting data to other sources from the processing device. Embodiments of network interface subsystem 416 include an Ethernet card, a modem (telephone, satellite, cable, ISDN, etc.), (asynchronous) digital subscriber line (DSL) units, and the like.

User interface input devices 412 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term input device is intended to include all possible types of devices and ways to input information to processing device.

User interface output devices 414 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term output device is intended to include all possible types of devices and ways to output information from the processing device. Storage subsystem 406 may be configured to store the basic programming and data constructs that provide the functionality in accordance with embodiments of the present invention. For example, according to one embodiment of the present invention, software modules implementing the functionality of the present invention may be stored in storage subsystem 206. These software modules may be executed by processor(s) 402. Storage subsystem 406 may also provide a repository for storing data used in accordance with the present invention. Storage subsystem 406 may include, for example, memory subsystem 408 and file/disk storage subsystem 410.

Memory subsystem 408 may include a number of memories including a main random access memory (RAM) 418 for storage of instructions and data during program execution and a read only memory (ROM) 420 in which fixed instructions are stored. File storage subsystem 410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 404 provides a mechanism for enabling the various components and subsystems of the processing device to communicate with each other. Although bus subsystem 404 is shown schematically as a single bus, alternative embodiments of the bus subsystem may utilize multiple busses.

The processing device may be of varying types including a personal computer, a portable computer, a workstation, a network computer, a mainframe, a kiosk, or any other data processing system. It is understood that the description of the processing device depicted in FIG. 4 is intended only as one example Many other configurations having more or fewer components than the system shown in FIG. 2 are possible.

The above embodiments of the present invention are illustrative and not limiting. Various alternatives and equivalents are possible. Other additions, subtractions or modifications are obvious in view of the present disclosure and are intended to fall within the scope of the appended claims.

What is claimed is:

1. A method for performing a computational task under the direction of a central server infrastructure, the method comprising:
forming a network of processing devices, each processing device being controlled by and associated with a different one of a plurality of entities;
each of the processing devices creating a respective initial pool of algorithms;
enabling the algorithms to evolve over time;
the central server infrastructure selecting one or more of the evolved algorithms in accordance with a predefined condition; and
applying the selected one or more algorithms to perform the computational task, wherein said computational task represents a financial algorithm.

2. The method of claim 1 further comprising:
compensating the plurality of entities for use of their associated processing devices.

3. The method of claim 1 wherein at least one of the processing devices comprises a cluster of central processing units.

4. The method of claim 1 wherein at least one of the entities is compensated financially.

5. The method of claim 1 wherein at least one of the processing devices comprises a central processing unit and a host memory.

6. The method of claim 1 wherein at least one of the said algorithms provides a measure of a risk-adjusted performance of one or more assets.

7. The method of claim 1 wherein at least one of the entities is compensated in goods/services.

8. The method of claim 1, wherein the step of each of the processing devices creating a respective initial pool of algorithms comprises the step of each of the processing devices creating a respective initial pool of algorithms randomly.

9. A networked computer system configured to perform a computational task, the networked computer system comprising:
a plurality of processing devices each configured to create a respective initial pool of algorithms, said algorithms being enabled to evolve over time;
a central server infrastructure configured to select one or more of the evolved algorithms in accordance with a predefined condition; and
a module configured to apply the selected one or more algorithms to perform the computational task, said computational task representing a financial algorithm.

10. The networked computer system of claim 9 further comprising:
a module configured to maintain a compensation level for each of the plurality of processing devices.

11. The networked computer system of claim 9 wherein at least one of the processing devices comprises a cluster of central processing units.

12. The networked computer system of claim 9 wherein at least one compensation is a financial compensation.

13. The networked computer system of claim 9 wherein at least one of the processing devices comprises a central processing unit and a host memory.

14. The networked computer system of claim 9 wherein at least one of the algorithms provides a measure of a risk-adjusted performance of one or more assets.

15. The networked computer system of claim 9, wherein each of the processing devices creates the respective initial pool of algorithms randomly.

16. A method for performing a computational task under the direction of a central controller, the method comprising:
forming a network of processing devices, different ones of the processing devices being controlled by and associated with different ones of a plurality of entities, the step of forming including providing to each of the processing devices client-side software code to be executed;
the central controller causing each of the processing devices to create a respective initial pool of algorithms, the client-side software code enabling the algorithms to evolve over time;
the central controller selecting one or more of the evolved algorithms in accordance with a predefined condition; and
applying the selected one or more algorithms to perform the computational task, wherein said computational task represents a financial algorithm.
